(19) United States
(12) Patent Application Publication
(10) Pub. No.: US 2009/0094698 A1
(43) Pub. Date: Apr. 9, 2009

(54) METHOD AND SYSTEM FOR EFFICIENTLY SCANNING A COMPUTER STORAGE DEVICE FOR PESTWARE

(76) Inventors: Anthony Lynn Nichols, Erie, CO (US); Michael Burtscher, Longmont, CO (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/869,528

(22) Filed: Oct. 9, 2007

(51) Int. Cl. G06F 11/30

(52) U.S. Cl. 726/24

(57) ABSTRACT

A method and system for efficiently scanning a computer storage volume for pestware is described. One embodiment determines whether a file on the storage device has been modified since it was last scanned for pestware; includes the file in a set of files to be scanned for pestware when it is determined that the file has been modified since it was last scanned for pestware; omits the file from the set of files to be scanned for pestware when it is determined that the file has not been modified since it was last scanned for pestware; scans the files in the set of files for pestware; and reports results of the pestware scan to a user.

### RELATED APPLICATIONS

The present application is related to the following commonly owned and assigned patent applications: U.S. Application No. (unassigned), Attorney Docket No. WEBR-062/00US, entitled “Method and System for Storing Information Within Attribute Data of a File,” filed herewith; U.S. application Ser. No. 11/237,575, Attorney Docket No. WEBR-025/00US, entitled “System and Method for Removing Residual Data from Memory,” filed on Sep. 28, 2005; U.S. application Ser. No. 11/386,594, Attorney Docket No. WEBR-040/00US, entitled “Method and System for Rapid Data-Fragmentation Analysis of a New Technology File System (NTFS),” filed on Mar. 22, 2006; and U.S. application Ser. No. 11/363,819, Attorney Docket No. WEBR-042/00US, entitled “System and Method for Obtaining File Information and Data Locations,” filed on Feb. 28, 2006; each of which is incorporated herein by reference in its entirety.

### FIELD OF THE INVENTION

The present invention relates to computer system management. In particular, but not by way of limitation, the present invention relates to methods and systems for efficiently scanning a computer storage device for pestware or malware.

### BACKGROUND OF THE INVENTION

Personal computers and business computers are continually attacked by viruses, trojans, worms, spyware, keyloggers, adware, and other forms of “malware” or “pestware.” Such programs are referred to hereinafter as “pestware.” Some types of pestware (e.g., spyware) gather information about a person or organization—often without the person or organization's knowledge. Some pestware is highly malicious. Other pestware is non-malicious but may cause issues with privacy or system performance.

Software is available to detect and remove pestware, but scanning a system for pestware typically requires a system to look at files stored in a data storage device (e.g., a hard disk drive) on a file-by-file basis. This process of scanning files is frequently time consuming, especially if every file on the data storage device is analyzed. As a result, users must wait a substantial amount of time to find out the results of a complete system scan. Even worse, some users elect not to perform a complete system scan because they do not want to, or cannot, wait for such a time-consuming scan to be completed.

It is thus apparent that there is a need in the art for an improved method and system for efficiently scanning a computer storage device for pestware.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

The present invention can provide a method and system for efficiently scanning a computer storage device for pestware. One illustrative embodiment is a method for scanning a storage device of a computer for pestware, the method comprising determining whether a file on the storage device has been modified since it was last scanned for pestware; including the file in a set of files to be scanned for pestware when it is determined that the file has been modified since it was last scanned for pestware; omitting the file from the set of files to be scanned for pestware when it is determined that the file has not been modified since it was last scanned for pestware; scanning the files in the set of files for pestware; and reporting results of the scanning to a user.

Another illustrative embodiment is a digital computer, comprising at least one processor; a display; and a memory containing a plurality of program instructions configured to cause the at least one processor to determine whether a file on a storage device of the digital computer has been modified since it was last scanned for pestware, include the file in a set of files to be scanned for pestware when it is determined that the file has been modified since it was last scanned for pestware, omit the file from the set of files to be scanned for pestware when it is determined that the file has not been modified since it was last scanned for pestware, perform a scan for pestware of the files in the set of files, and report results of the scan to a user via the display.

These and other embodiments are described in further detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings, wherein:

FIG. 1 is a functional block diagram of a digital computer equipped with a pestware control system in accordance with an illustrative embodiment of the invention;

FIG. 2 is a flowchart of a method for scanning a storage device of a computer for pestware in accordance with an illustrative embodiment of the invention;

FIG. 3 is a flowchart of a method for scanning a storage device of a computer for pestware in accordance with another illustrative embodiment of the invention;

FIGS. 4A and 4B are a flowchart of a method for scanning a storage device of a computer for pestware in accordance with yet another illustrative embodiment of the invention;

FIG. 5 is a diagram of a portion of a Master File Table (MFT) of a New-Technology-File-System (NTFS) volume containing extended-attribute data in accordance with an illustrative embodiment of the invention; and

FIG. 6 is a diagram of a portion of a MFT of a NTFS volume containing user-defined attribute data in accordance with another illustrative embodiment of the invention.

### DETAILED DESCRIPTION

In an illustrative embodiment of the invention, a pestware control system protecting a computer from pestware determines in a rapid and efficient manner which files on a storage device of the computer have been modified since they were last scanned for pestware. In a subsequent pestware scan, the pestware control system scans only those files that have been modified since they were last scanned for pestware. This avoids needless rescanning of files that have already been deemed not to be pestware objects. The time savings realized by scanning only the files that need to be scanned can be as much as a factor of one hundred on some computers. This significantly reduces the inconvenience to the user associated with a pestware scan and increases the likelihood that the user will schedule or permit such a scan on a regular basis, thereby improving the security and data integrity of the system.

In some embodiments, additional attribute data above and beyond the standard attribute data associated with files are stored with each individual file in the file system to provide the information needed to determine whether a given file has been modified since it was last scanned for pestware. Such additional attribute data can be implemented as “extended attributes” that are provided for by the operating system (e.g., MICROSOFT WINDOWS), or a custom driver can be written to implement “user-defined attributes” that are in conformance with but independent of the operating system.

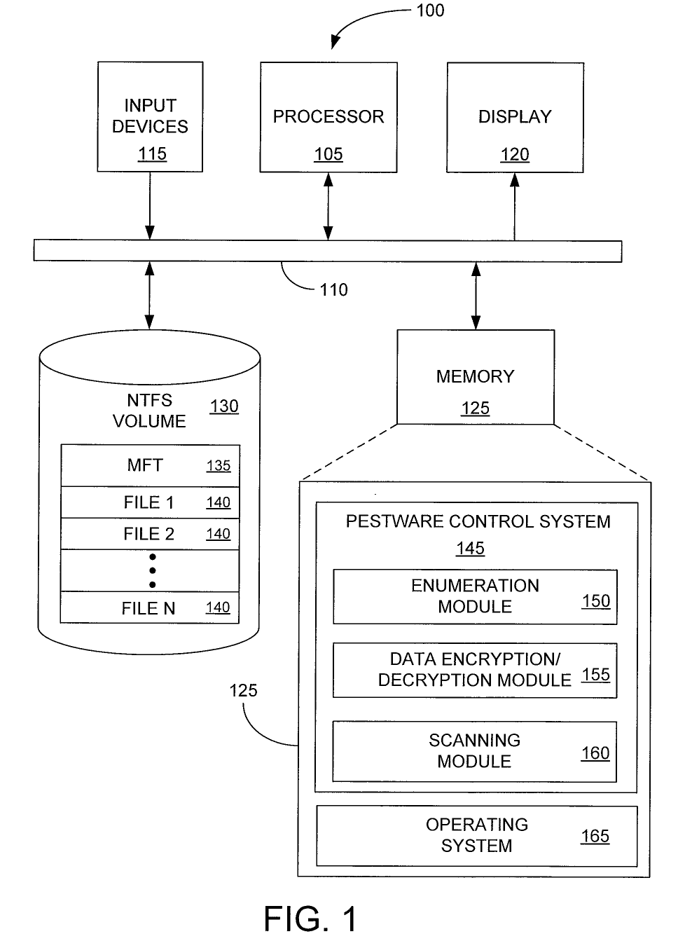

Referring now to the drawings, where like or similar elements are designated with identical reference numerals throughout the several views, and referring in particular to FIG. 1, it is a functional block diagram of a digital computer (“computer”) 100 equipped with a pestware control system 145 in accordance with an illustrative embodiment of the invention. Computer 100 may be a desktop computer, workstation, laptop computer, notebook computer, handheld computer, or any other device that includes computing functionality. In FIG. 1, processor 105 communicates over data bus 110 with input devices 115, display 120, memory 125, and New-Technology-Pile-System (NTFS) volume 130. In some embodiments, NTFS volume 130 resides on a storage device such as a hard disk drive (HDD). In other embodiments, NTFS volume 130 can be any type of rewritable NTFS volume, including, without limitation, magnetic disks, rewritable optical discs, and flash-memory-based storage media such as secure digital (SD) cards and multi-media cards (MMCs).

Input devices 115 may be, for example, a keyboard and a mouse or other pointing device. Memory 125 may include random-access memory (RAM), read-only memory (ROM), flash memory, or a combination thereof.

NTFS volume 130 includes Master File Table (MFT) 135 and associated files 140. Additional background regarding NTFS file systems in the context of illustrative embodiments of the invention is provided below.

Memory 125 includes pestware control system 145 and operating system 165. In one embodiment, operating system 165 is a version of MICROSOFT WINDOWS (e.g., WINDOWS 98, WINDOWS NT, WINDOWS 2000, WINDOWS CE, WINDOWS ME, WINDOWS XP, WINDOWS VISTA, etc.). In other embodiments, the principles of the invention may be applied to other operating systems and to file systems other than NTFS (e.g., FAT 16).

For convenience in this Detailed Description, the functionality of pestware control system 145 has been divided into three functional modules: enumeration module 150, data encryption/decryption module (“crypto module”) 155, and scanning module 160. In various embodiments of the invention, the functionality of these modules may be combined or subdivided in a variety of ways different from that indicated in FIG. 1. Also, these functional modules may be implemented in software, firmware, hardware, or any combination thereof. In some embodiments, the above functional modules are embodied as program instructions executable by processor 105 and stored on a computer-readable storage medium, the various functions performed by the modules being assigned to a plurality of instruction segments. The computer-readable storage medium can include, without limitation, a hard disk drive, a floppy disk, an optical disc, a flash-memory-based storage device, or other computer-readable medium.

In this illustrative embodiment, enumeration module 150 is configured to identify which files 140 in NTFS volume 130 should be scanned for pestware during a current pestware scan to be performed. The current pestware scan may have been scheduled in advance, or it may have been requested at an arbitrary time by a user. Enumeration module 150 is configured to determine which files 140 have been modified since they were last scanned for pestware. Those files 140 (and any files created since the last volume-wide pestware scan was performed) should be scanned for pestware. Once enumeration module 150 has identified the set of files 140 to be scanned for pestware, enumeration module 150 communicates that information to scanning module 160, which scans the indicated set of files for pestware.

Scanning module 160 is configured to analyze files 140 to determine whether or not they are potential pestware objects. Scanning module 160 is configured to employ a variety of techniques to identify potential pestware. These techniques may include, for example, identifying specific data in a file 140 that is unique to a particular type of known pestware; comparing an MD5 hash value, CRC, or other “digital signature” of the file 140 with that of a particular type of known pestware; and other techniques. In general, the information on which scanning module 160 relies in performing pestware scans is referred to herein as “pestware definitions.” A collection of such pestware definitions may be updated as needed as new forms of pestware are discovered.

The function of crypto module 155 is explained below.

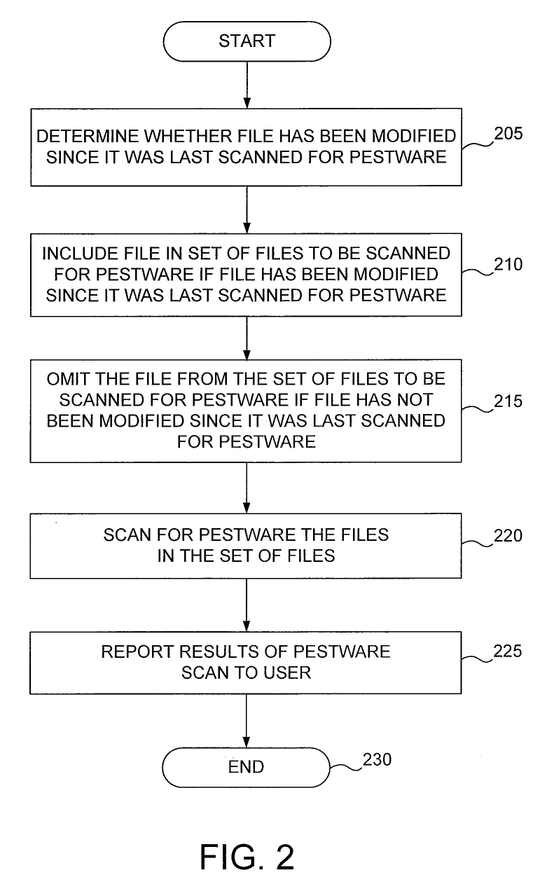

FIG. 2 is a flowchart of a method for scanning a storage device of a computer for pestware in accordance with an illustrative embodiment of the invention. At 205, enumeration module 150 determines whether a file 140 has been modified since it was last scanned for pestware. If the file 140 has been modified since it was last scanned for pestware at 210, enumeration module 150 includes the file 140 in a set of files 140 to be scanned for pestware. If the file 140 has not been modified since it was last scanned for pestware at 215, enumeration module 150 omits (excludes) the file 140 from the set of files 140 to be scanned for pestware. At 220, scanning module 160 scans the set of files 140 identified by enumeration module 150. At 225, pestware control system 145 reports to a user the results of the pestware scan performed at 220. In one embodiment, pestware control system 145 reports the results on display 120, allowing the user to take corrective action (e.g., removal or quarantining of files 140 flagged as potential pestware objects). Optionally, scanning module 160 may also save a log file containing the results of the pestware scan. At 230, the process terminates.

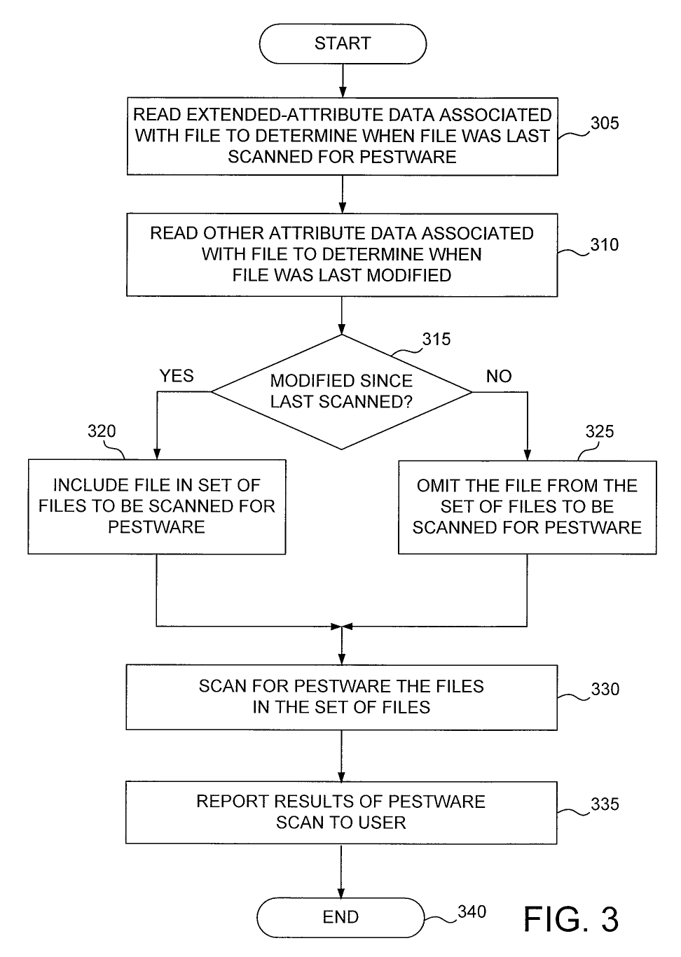

FIG. 3 is a flowchart of a method for scanning a storage device of a computer for pestware in accordance with another illustrative embodiment of the invention. FIG. 3 illustrates one of a variety of ways in which a method such as that shown in FIG. 2 may be implemented. At 305, enumeration module 150 reads previously-written extended-attribute data associated with a file 140 to determine when the file 140 was last scanned for pestware. For example, the extended-attribute data may contain a date and time indicating when the file 140 was last analyzed to determine whether it is a potential pestware object. During each pestware scan, scanning module 160 can record such extended-attribute data for each file 140 as it is being scanned. During subsequent pestware scans, the extended-attribute data provides a simple and efficient way for enumeration module 150 to determine when the file 140 was last scanned for pestware. This special metadata is referred to as “extended” attribute data because it is added by pestware control system 145 and goes beyond the usual attribute data associated with a file 140 that is maintained by the operating system 165 (e.g., file name, date created, date last modified, date last accessed, etc.). Additional details regarding the extended-attribute data and user-defined attribute data are provided below.

At 310, enumeration module 150 reads other attribute data associated with the file 140 to determine when the file was last modified. The date and time of last modification is standard attribute data that is available for each file 140 in an NTFS volume 130.

At 315, enumeration module 150 determines, based on when the file 140 was last scanned for pestware (see Block 305) and when the file 140 was last modified (see Block 310), whether the file 140 has been modified since it was last scanned for pestware. If so, the file 140 is included in a set of files 140 to be scanned for pestware at 320. If not, the file 140 is omitted from the set of files to be scanned for pestware at 325.

At 330, scanning module 160 scans for pestware the set of files identified by enumeration module 150. Pestware control system 145 reports the results of the current pestware scan to a user at 335. At 340, the process terminates.

Even though a particular file has not changed since it was last scanned for pestware, the definitions that the pestware control system uses to identify pestware might have been updated since the file was last scanned. New pestware is discovered frequently, and pestware control systems (e.g., anti-virus or anti-spyware programs) are typically updated with the latest pestware definitions shortly after new pestware is discovered. To accommodate this situation, some embodiments include in the set of files to be scanned for pestware those files that have not been modified since they were last scanned for pestware but which were scanned before the latest update of the collection of pestware definitions in pestware control system 145.

In such a case, a digital signature such as an MD5 hash value or a cyclic redundancy check (CRC) computed for the contents of a file 140 in a previous pestware scan and stored among the extended-attribute data mentioned above can be retrieved and passed along to scanning module 160. This embodiment thus avoids having to recalculate a digital signature for a file 140 that has not been modified since it was last scanned for pestware. Scanning module 160 can perform an abbreviated pestware scan of such a file by comparing the already-computed-and-still-valid digital signature retrieved from the file's extended-attribute data with the digital signatures of the various pestware objects in the updated collection of pestware definitions. In an abbreviated scan, there is no need to access the file's contents because the digital signature is already available from the file's extended-attribute data.

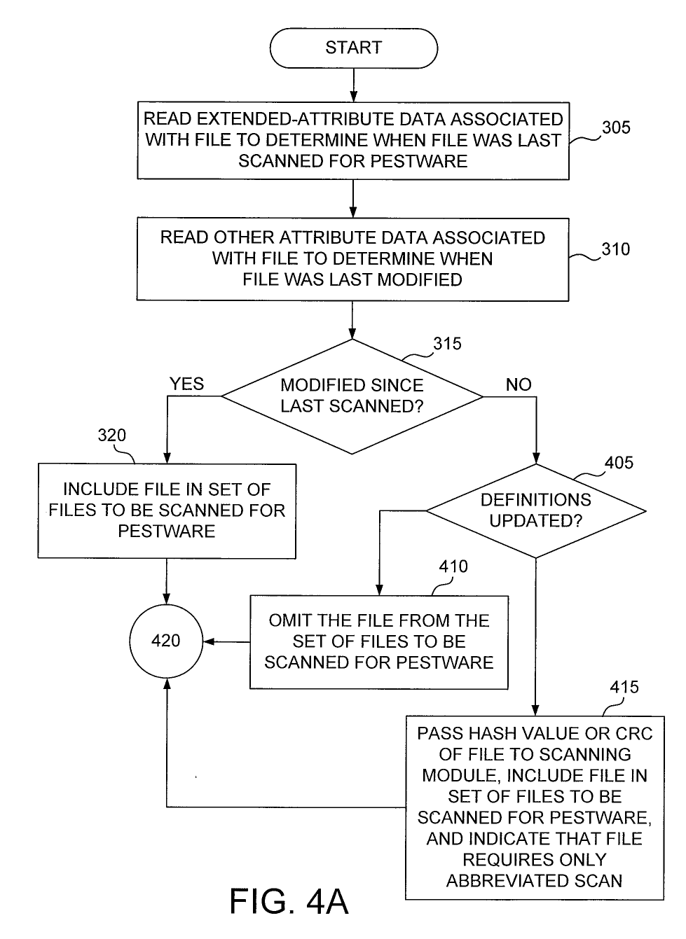

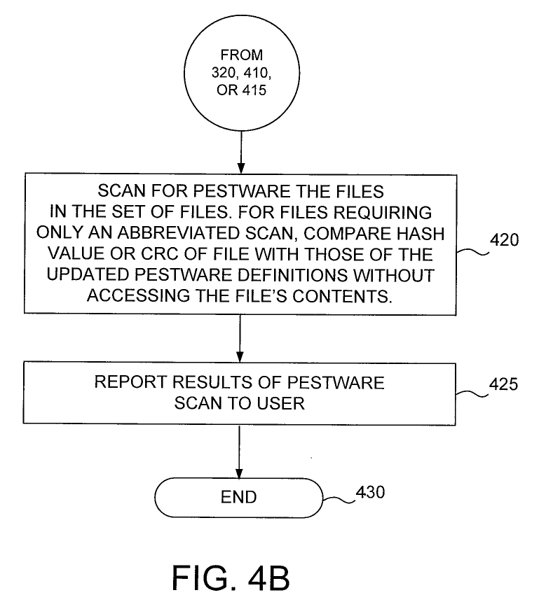

FIGS. 4A and 4B are a flowchart of a method for scanning a storage device of a computer for pestware in accordance with yet another illustrative embodiment of the invention. Referring first to FIG. 4A, the method shown in FIGS. 4A and 4B proceeds as in FIG. 3 through Block 320. At 405, enumeration module 150 determines whether, even though a file 140 has not been modified since it was last scanned for pestware, the pestware definitions of pestware control system 145 have been updated since that file 140 was last scanned for pestware. If not, the file 140 is omitted from the set of files to be scanned for pestware at 410, and the process proceeds to Block 420 in FIG. 4B. If so, enumeration module 150, at 415, passes the hash value, CRC, or other digital signature of the file 140 retrieved from its extended-attribute data to scanning module 160. At 415, enumeration module 150 also indicates to scanning module 160 that the file 140 is to be included in the set of files 140 to be scanned for pestware but that only an abbreviated scan is needed, as explained above.

Referring to FIG. 4B, scanning module 160, at 420, scans the files in the set of files 140 identified by enumeration module 150. For files 140 that enumeration module 150 has flagged accordingly and for which a digital signature has been retrieved from their associated extended-attribute data and passed along to scanning module 160, scanning module 160 performs an abbreviated scan. At 425, pestware control system 145 reports the results of the current pestware scan to a user. The process terminates at 430.

To facilitate the description of additional details regarding extended attributes of files 140, a brief overview of some aspects of the NTFS architecture will next be provided. NTFS volume 130 is divided into units of storage called clusters. Typically, 12 percent of NTFS volume 130 is reserved for MFT 135 to reduce the probability of the MFT 135 becoming fragmented, and a copy of the first 4 MFT records resides at the end of the volume to facilitate data recovery in case the original MFT records become corrupted. The remaining portions of NTFS volume 130 are available for data external to MFT 135. The NTFS architecture treats all system components as files 140, and the MFT 135 is a special file that is much like a relational database table. MFT 135 contains a record (typically 1 KB long) for each file on NTFS volume 130 (folders are also treated as “files”).

Each file or folder on NTFS volume 130 includes a set of attributes in its corresponding MFT record. Attributes include information such as name, creation date, last-modified date, file type, security information, even the file's data itself. Operating systems such as the WINDOWS operating systems mentioned above also set aside an area of each MFT record for extended attributes. Within a given MFT record, such extended attributes lie below address 0x1000 (hexadecimal). The WINDOWS operating system has built-in functions for storing and manipulating these kinds of operating-system-supported extended attributes. If a programmer desires to create and use attributes apart from those provided for by WINDOWS (“user-defined attributes”), they must be stored at address 0x1000 or higher, and the programmer typically must write a custom driver to support the user-defined attributes. Techniques for coding such a driver are well known to those skilled in the relevant art.

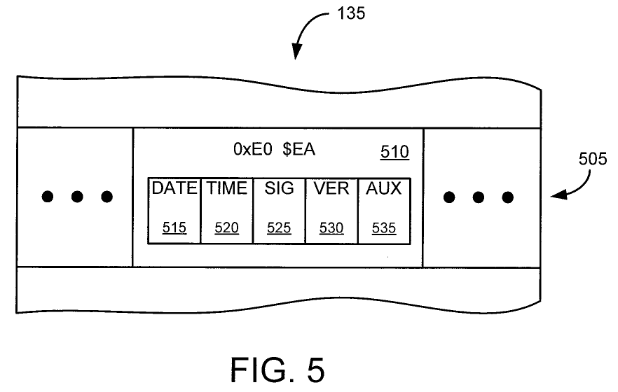

FIG. 5 is a diagram of a portion of MFT 135 of NTFS volume 130 containing extended-attribute data in accordance with an illustrative embodiment of the invention. FIG. 5 shows a MFT record 505 corresponding to an arbitrary file 140. Among the many attributes associated with file 140 is extended-attribute (“EA”) 510 (at address 0xE0 in this example). EA 510 may be of arbitrary size. In this embodiment, EA 510 includes date 515, time 520, signature (“SIG”) 525, version (“VER”) 530, and auxiliary data (“AUX”) 535. Each will be described in turn.

Date 515 and time 520 indicate when the file 140 associated with MFT record 505 was last scanned for pestware. As explained above, scanning module 160 can record these extended-attribute data each time a given file 140 is scanned for pestware. SIG 525 is a digital signature such as an MD5 hash value or CRC computed for the contents of the file 140. It remains valid until file 140 is modified. VER 530 is the version of the pestware definitions used to scan file 140 for pastware when it was last scanned. AUX 535 is data added to the other extended-attribute data to make it possible for pestware control system 145 to determine whether the extended-attribute data of EA 510 have been tampered with (e.g., pestware might attempt to delete or corrupt the extended-attribute data to defeat pestware control system 145). Examples of auxiliary data include, without limitation, a CRC, one or more parity bits, or some other form of checksum.

Not all of the extended-attribute data shown in FIG. 5 are necessarily present in all embodiments. Depending on the embodiment, a subset of these values may be used, and some embodiments may include additional extended-attribute data beyond those depicted in FIG. 5. For example, though it is advantageous to have both date 515 and time 520, time 520 may be omitted in some embodiments where coarse identification of when a file 140 was last scanned is sufficient. Those skilled in the art will recognize that a wide variety of other extended-attribute data could be added to MFT record 505 by pestware control system 145.

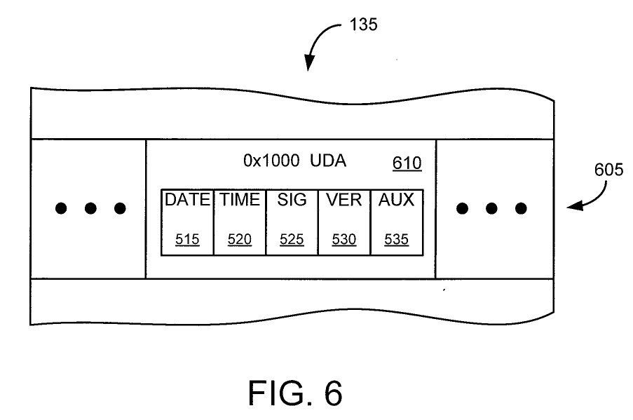

FIG. 6 is a diagram of a portion of MFT 135 of NTFS volume 130 containing user-defined attribute data in accordance with another illustrative embodiment of the invention. FIG. 6 illustrates a MFT record 605 corresponding to an arbitrary file 140. In this embodiment, the attribute data used by pestware control system 145 are implemented as user-defined attribute (“UDA”) 610 at address 0x1000. As explained above, in such an embodiment, the programmer can write a custom driver to implement the user-defined attribute data of UDA 610.

As mentioned above, the extended-attribute or user-defined attribute data may be vulnerable to deletion or tampering by pestware unless steps are taken to prevent it. One such step—including auxiliary data among the extended-attribute or user-defined attribute data that makes it possible to detect tampering—was described above. Another technique is to encrypt the extended-attribute or user-defined attribute data. This is the role of crypto module 155 (see FIG. 1) of pestware control system 145. Crypto module 155 can be configured to encrypt the extended-attribute or user-defined attribute data as they are written to NTFS volume 130 and to decrypt these data when they are read from NTFS volume 130. Encryption techniques such as public-key encryption are well known in the art and may be employed in the context of the above illustrative embodiments of the invention. In some embodiments, a less robust protection (e.g., a simple encoding algorithm) may be employed. In still other embodiments, the encryption may be of the “rolling-key” type.

In conclusion, the present invention provides, among other things, a method and system for efficiently scanning a computer storage device for pestware. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the disclosed invention as expressed in the claims.

What is claimed is:

1. A method for scanning a storage device of a computer for pestware, the method comprising:
reading extended-attribute data associated with a file on the storage device to determine when the file was last scanned for pestware, the extended-attribute data including a date and time indicating when the file was last analyzed to determine whether the file is a potential pestware object, the extended-attribute data having been written to the storage device when the file was last scanned for pestware;
reading other attribute data associated with the file to determine when the file was last modified;
determining, based on when the file was last scanned for pestware and when the file was last modified, whether the file has been modified since the file was last scanned for pestware;
including the file in a set of files to be scanned for pestware when it is determined that the file has been modified since the file was last scanned for pestware;
omitting the file from the set of files to be scanned for pestware when it is determined that the file has not been modified since the file was last scanned for pestware;
scanning the files in the set of files for pestware; and
reporting results of the scanning to a user.

2. The method of claim 1, wherein the extended-attribute data are encrypted and reading the extended-attribute data associated with the file includes decrypting the encrypted extended-attribute data.

3. The method of claim 1, wherein the extended-attribute data include auxiliary data for determining whether the extended-attribute data have been tampered with.

4. The method of claim 1, wherein the extended-attribute data include a hash value of the file computed during a previous pestware scan, the file is included in the set of files to be scanned for pestware when the file has not been modified since the file was last scanned for pestware and a collection of pestware definitions has been updated since the file was last scanned for pestware, and scanning the file for pestware includes comparing the hash value with at least one pestware hash value associated with the updated collection of pestware definitions without accessing the file's contents.

5. The method of claim 1, wherein the extended-attribute data include a cyclic redundancy check (CRC) of the file computed during a previous pestware scan, the file is included in the set of files to be scanned for pestware when the file has not been modified since the file was last scanned for pestware and a collection of pestware definitions has been updated since the file was last scanned for pestware, and scanning the file for pestware includes comparing the CRC with at least one pestware CRC associated with the updated collection of pestware definitions without accessing the file's contents.

6. The method of claim 1, wherein the extended-attribute data include an indication of what version of a collection of pestware definitions was used to scan the file when the file was last scanned for pestware.

7. The method of claim 1, wherein the file resides in a New-Technology-File-System (NTFS) volume and the extended-attribute data are written to a portion of a Master File Table (MFT) of the NTFS volume that is set aside for extended attributes by an operating system of the computer.

8. The method of claim 1, wherein the file resides in a New-Technology-File-System (NTFS) volume and the extended-attribute data are instead user-defined attribute data written to a portion of a Master File Table (MFT) of the NTFS volume outside a portion of the MFT that is set aside for extended attributes by an operating system of the computer.

9. A method for scanning a storage device of a computer for pestware, the method comprising:
determining whether a file on the storage device has been modified since it was last scanned for pestware;
including the file in a set of files to be scanned for pestware when it is determined that the file has been modified since it was last scanned for pestware;
omitting the file from the set of files to be scanned for pestware when it is determined that the file has not been modified since it was last scanned for pestware;
scanning the files in the set of files for pestware; and
reporting results of the scanning to a user.

10. The method of claim 9, wherein determining whether a file on the storage device has been modified since it was last scanned for pestware includes:
reading and decrypting encrypted extended-attribute data associated with the file to determine when the file was last scanned for pestware, the decrypted extended-attribute data including a date and time indicating when the file was last analyzed to determine whether the file is a potential pestware object, the encrypted extended-attribute data having been written to the storage device when the file was last scanned for pestware; and
reading other attribute data associated with the file to determine when the file was last modified.

11. A digital computer, comprising:
at least one processor;
a display; and
a memory containing a plurality of program instructions configured to cause the at least one processor to:
read extended-attribute data associated with a file on a storage device of the digital computer to determine when the file was last scanned for pestware, the extended-attribute data including a date and time indicating when the file was last analyzed to determine whether the file is a potential pestware object, the extended-attribute data having been written to the storage device when the file was last scanned for pestware;
read other attribute data associated with the file to determine when the file was last modified;
determine, based on when the file was last scanned for pestware and when the file was last modified, whether the file has been modified since the file was last scanned for pestware;
include the file in a set of files to be scanned for pestware when it is determined that the file has been modified since the file was last scanned for pestware;
omit the file from the set of files to be scanned for pestware when it is determined that the file has not been modified since the file was last scanned for pestware;
perform a scan for pestware of the files in the set of files; and
report results of the scan to a user via the display.

12. The digital computer of claim 11, wherein the plurality of program instructions are configured to cause the at least one processor to encrypt the extended-attribute data when the extended-attribute data are written to the storage device and to decrypt the encrypted extended-attribute data when the extended-attribute data are read from the storage device.

13. The digital computer of claim 11, wherein the extended-attribute data include auxiliary data for determining whether the extended-attribute data have been tampered with.

14. The digital computer of claim 11, wherein the extended-attribute data include a hash value of the file computed during a previous pestware scan, the plurality of program instructions are configured to cause the at least one processor to include the file in the set of files to be scanned for pestware when the file has not been modified since the file was last scanned for pestware and a collection of pestware definitions has been updated since the file was last scanned for pestware, and the plurality of program instructions are configured to cause the at least one processor to scan the file for pestware by comparing the hash value with at least one pestware hash value associated with the updated collection of pestware definitions without accessing the file's contents.

15. The digital computer of claim 11, wherein the extended-attribute data include a cyclic redundancy check (CRC) of the file computed during a previous pestware scan, the plurality of program instructions are configured to cause the at least one processor to include the file in the set of files to be scanned for pestware when the file has not been modified since the file was last scanned for pestware and a collection of pestware definitions has been updated since the file was last scanned for pestware, and the plurality of program instructions are configured to cause the at least one processor to scan the file for pestware by comparing the CRC with at least one pestware CRC associated with the updated collection of pestware definitions without accessing the file's contents.

16. The digital computer of claim 11, wherein the extended-attribute data include an indication of what version of a collection of pestware definitions was used to scan the file when the file was last scanned for pestware.

17. The digital computer of claim 11, wherein the file resides in a New-Technology-File-System (NTFS) volume and the extended-attribute data are written to a portion of a Master File Table (MFT) of the NTFS volume that is set aside for extended attributes by an operating system of the digital computer.

18. The digital computer of claim 11, wherein the file resides in a New-Technology-File-System (NTFS) volume and the extended-attribute data are instead user-defined attribute data that are written to a portion of a Master File Table (MFT) of the NTFS volume outside a portion of the MFT that is set aside for extended attributes by an operating system of the digital computer.

19. A digital computer, comprising:
at least one processor;
a display; and
a memory containing a plurality of program instructions configured to cause the at least one processor to:
determine whether a file on a storage device of the digital computer has been modified since it was last scanned for pestware;
include the file in a set of files to be scanned for pestware when it is determined that the file has been modified since it was last scanned for pestware;
omit the file from the set of files to be scanned for pestware when it is determined that the file has not been modified since it was last scanned for pestware;
perform a scan for pestware of the files in the set of files; and
report results of the scan to a user via the display.

20. The digital computer of claim 19, wherein, to determine whether a file on the storage device has been modified since it was last scanned for pestware, the plurality of program instructions are configured to cause the at least one processor to:
read and decrypt encrypted extended-attribute data associated with the file to determine when the file was last scanned for pestware, the decrypted extended-attribute data including a date and time indicating when the file was last analyzed to determine whether the file is a potential pestware object, the encrypted extended-attribute data having been written to the storage device when the file was last scanned for pestware; and
read other attribute data associated with the file to determine when the file was last modified.

21. A computer-readable storage medium containing a plurality of program instructions executable by a processor, the plurality of program instructions comprising:
a first instruction segment configured to cause the processor to read extended-attribute data associated with a file on a storage device of a computer to determine when the file was last scanned for pestware, the extended-attribute data including a date and time indicating when the file was last analyzed to determine whether the file is a potential pestware object, the extended-attribute data having been written to the storage device when the file was last scanned for pestware;
a second instruction segment configured to cause the processor to read other attribute data associated with the file to determine when the file was last modified;
a third instruction segment configured to cause the processor to determine, based on when the file was last scanned for pestware and when the file was last modified, whether the file has been modified since the file was last scanned for pestware;
a fourth instruction segment configured to cause the processor to include the file in a set of files to be scanned for pestware when the third instruction segment has caused the processor to determine that the file has been modified since the file was last scanned for pestware and configured to cause the processor to omit the file from the set of files to be scanned for pestware when the third instruction segment has caused the processor to determine that the file has not been modified since the file was last scanned for pestware;
a fifth instruction segment configured to cause the processor to perform a scan for pestware of the files in the set of files; and
a sixth instruction segment configured to cause the processor to report results of the scan to a user.

22. The computer-readable storage medium of claim 21, wherein the plurality of program instructions are configured to cause the processor to encrypt the extended-attribute data when the extended-attribute data are written to the storage device and to decrypt the encrypted extended-attribute data when the extended-attribute data are read from the storage device.

23. The computer-readable storage medium of claim 21, wherein the extended-attribute data include auxiliary data for determining whether the extended-attribute data have been tampered with.

24. The computer-readable storage medium of claim 21, wherein the extended-attribute data include a hash value of the file computed during a previous pestware scan, the fourth instruction segment is configured to cause the processor to include the file in the set of files to be scanned for pestware when the file has not been modified since the file was last scanned for pestware and a collection of pestware definitions has been updated since the file was last scanned for pestware, and the fifth instruction segment is configured to cause the processor to scan the file for pestware by comparing the hash value with at least one pestware hash value associated with the updated collection of pestware definitions without accessing the file's contents.

25. The computer-readable storage medium of claim 21, wherein the extended-attribute data include a cyclic redundancy check (CRC) of the file computed during a previous pestware scan, the fourth instruction segment is configured to cause the at least one processor to include the file in the set of files to be scanned for pestware when the file has not been modified since the file was last scanned for pestware and a collection of pestware definitions has been updated since the file was last scanned for pestware, and the fifth instruction segment is configured to cause the at least one processor to scan the file for pestware by comparing the CRC with at least one pestware CRC associated with the updated collection of pestware definitions without accessing the file's contents.
